(19) United States
(12) Patent Application Publication
(10) Pub. No.: US 2008/0067722 A1
(43) Pub. Date: Mar. 20, 2008

(54) PROCESS AND DEVICE FOR PRODUCING A THREE-DIMENSIONAL OBJECT FROM A SOLIDIFIABLE MATERIAL

(75) Inventor: Jialin Shen, Bernstadt (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/849,678

(22) Filed: Sep. 4, 2007

(30) Foreign Application Priority Data
Sep. 20, 2006 (DE) 102006044044.7-24

(51) Int. Cl. B29C 35/08

(52) U.S. Cl. 264/401; 425/174.4

(57) ABSTRACT

The invention concerns a process and a device for the rapid technology for producing a three-dimensional object from a solifiable material, wherein a supplemental tempering occurs within the construction space.

### BACKGROUND OF THE INVENTION

The invention concerns a process and a device for producing a three-dimensional object from a solidifiable material. Processes and devices of this type are known, for example, from DE 1010612 C1 or DE 102005041559. Therein the solidifiable material can be in powder form as for example in DE 10108612 C1, or in liquid form as in the case of DE 102005041559.

DE 10108612 C1 describes the so-called selective laser sintering (SLS, Selective Laser Sintering). SLS is a rapid technology process, in which a platform (construction space floor) that can be lowered within the construction space carries a powder layer, which is heatable by a laser beam in selected areas, so that the powder particles melt to form a first layer. Subsequently the platform is lowered by 20 to 200 μm (depending upon particle size and type) and a new powder layer is applied. The laser beam follows a new track and melts the powder particles of the second layer to each other, as well as the second layer to the first layer, forming within it a solidified three-dimensional object, for example, an injection mold. Among other things the construction space is heated as a whole or over its upper surface, in order to reduce the additional energy input required for sintering.

In a similar manner, in the rapid technology process known as 3-D Printing (3-DP, three-dimensional printing), a powder layer is provided on a platform (construction space floor) that can be lowered in the construction space, and a liquid stream is impinged upon selected areas of the powder layer, whereby the powder particles are at least superficially dissolved or are triggered to chemically react with each other, so that the powder particles bond to form a first layer. Therein, as a consequence of the reaction, heat can also be evolved. A targeted pre-warming is possible also in the case of 3-DP in order for example, to accelerate the reaction speed.

Likewise, in similar manner, in stereolithography radiation sensitive liquid layers are solidified by radiation. Therein the radiation is conventionally UV radiation. However, it could also be IR radiation or liquid radiation or streams, for example, as disclosed in DE 102005044920 A1. Therein, likewise warming input could occur.

Instead of energy or liquid streams with narrow limited surface areas, it is also possible to radiate over a large surface area using masks, for example, with Selected Mask Sintering (SMS) according to EP 1015214 B1. Therein, likewise, warming can occur.

Within the construction space certain areas experience for longer or shorter periods of time—depending upon the geometry of the component being produced—the above mentioned warming by the radiation, while other areas are not warmed thereby. Besides this, only the respective uppermost material layer is warmed by radiation; the lower layers transmit the absorbed warmth to their environment and cool off. The result is inhomogeneous temperature distributions and thermal tensions within the “layer cake”, which could lead to component distortion. In SMS, depending upon the employed material, a pre-warming of the entire construction space may be necessary. This is, for example, the case in PA12. Above all, in the core of the construction space, a heat sink effect can develop, so that the powder cake becomes hard overall.

For minimizing this problem it has already been proposed in EP 556 291 B1 to adjust a uniform base temperature of the respective upper surface layer by means of a ring-shaped heat radiator provided parallel above it. It is intended that an even cooling of the individual layers results therefrom, and thus a smaller distortion of the component.

Research has however shown that temperature gradients continue to be exhibited between the individual layers, wherein in particular the first mentioned leads to component distortion, which is not tolerable, at least in qualitatively high value components. For this reason it is proposed in DE 10108612 C1 to heat the jacket of the construction space in such a manner that a temperature distribution is adjusted in the jacket, which temperature decreases going from the areas of the jacket bordering the last sintered upper surface of the layer cake in the direction towards the construction space floor.

Thereby the component distortion is substantially reduced. For particular applications however, there continues to be need for improvement.

### SUMMARY OF THE INVENTION

The invention is concerned with the task of providing a process and a device for producing a three-dimensional object from a solidifiable material in which component warpage attributable to the temperature gradient is further reduced.

### DETAILED DESCRIPTION OF THE INVENTION

With regard to the process to be provided and the device to be provided the invention is set forth in the characterizing portion of patent claims 1 and 5. The remaining patent claims set forth further advantageous embodiments and further developments of the invention.

With regard to the process for producing a three-dimensional object, the task is solved in accordance with the invention by the following steps:
applying and flattening a solidifiable liquid or powder-form material layer on a target surface,
radiating a selected part of the layer with an energy beam or a stream of material, corresponding to a cross section of the object, so that the material layer solidifies in this selected area, wherein the radiated area warms it's environment,
repeating the steps of the application and the radiation for a plurality of layers, which form a “layer cake”, such that the solidified parts of the adjacent layers bond to each other, in order to form an object.
   thereby characterized, that a tempering occurs within the layer cake.

The energy can be any type, for example, an electron beam or an IR-beam, preferably a laser beam, as long as the energy input into the material is only sufficient to bring about a local solidification on the material layer. For this, in the case of the use of powder materials, the particles impinged by the radiation need not completely melt. A partial melting or an energetic initiation of a chemical reaction could in certain cases likewise be sufficient.

In the event of use of a material stream, either a solid (particle beam) or liquid material (liquid, suspension, emulsion, deposit welding, etc.) could be streamed or jetted onto the target surface of the material layer.

In the case of use of a liquid stream, it could be advantageous that at least one component of the material layer is soluble in the liquid, or that a reaction is triggered as a result of an interaction with the liquid, which brings about a local solidification of the material layer in the area impinged by the liquid. The term “liquid stream” here includes not only a continuous stream, but rather in particular also individual droplets.

The term “layer cake” is understood to refer to the layer-wise application of powered cylinders within the construction space, which includes the solidified and non-solidified areas.

The inventively carried-out supplemental tempering (besides the tempering which occurs as a result of radiation) within the layer cake minimizes component distortion since the temperature distribution within the layer of the layer cake can thus be better homogenized and can drop off more evenly starting from the irradiated areas of the upper surface and going towards the floor of the construction space.

This homogenization of the temperature distribution within a layer and the gradual temperature reduction is achieved in that by means of a supplemental tempering within the layer cake a supplemental temperature distribution, with a temperature decreasing in the direction towards the construction floor, is super-imposed upon the temperature distribution caused by the radiation and, in certain cases, by the ring-shaped heat emitter and/or by a jacket heater. This supplemental temperature distribution should of course not reach a temperature which would bring about a spontaneous solidification of the material layer. Rather, it produces an essentially uniform base temperature to the individual material lavers, so that the heat output of the radiated areas within a layer is minimized and a thermal radiation or thermal flow from the radiated areas towards downwards, that is, perpendicular to the material layers, is promoted. A suitable temperature distribution is for example, linear.

Preferably the tempering occurs at multiple, preferably variable positions in at least one plane of the construction space. The positions could for example, lie in one layer plane of the layer cake, for other embodiments or application cases all positions on one plane perpendicular to the layering might be advantageous and, in yet another embodiment, a three-dimensionally distributed arrangement of the tempering position may also be advantageous. If the design possibilities of the tempering positions may be variable, then all these embodiments can advantageously be carried out in the same device.

The tempering can occur simultaneously in all positions, or also only in all positions in one plane, that is, respectively one uniform temperature is transmitted to the surrounding layer of material. It can however be even more advantageous when a different tempering occurs at different areas or positions within the construction space. For example, the tempering can occur depending on the distance of the respective tempering position from the contour of the object to be solidified within the layer cake, for example, a higher tempering at a greater distance to a comparatively warmer object by the super-imposing of the respective temperature distribution results in an overall more even temperature distribution.

With respect to such a more even temperature distribution, a control or regulation of the tempering is advantageous, whereby it occurs differentially preferably in different positions within the construction space.

For determining suitable control parameters, a simulation of the radiation process can be carried out for example with respect to achieving optimal reduction of the component distortion. It is particularly advantageous for the control of any type of temperature distribution to also make inputs which are, for example, non-linear and changing over time, which were optimized by means of a simulation of the laser sinter process with respect to achieving a reduction of the component distortion. A suitable simulation of the energy input of a laser in the powder layer of the layer cake has already been proposed, for example, in the German patent application DE 10050280 A1. The temperature distribution within the powder cake resulting from the energy input can be determined using known processes, for example, by solving the thermal conductivity equation, and likewise modeling the influencing of this temperature distribution by super-imposing a supplemental tempering within the construction space. Optimization processes are likewise known to the person of ordinary skill. Individual steps of the simulation can be experimentally verified or substituted.

For determining suitable control parameters the actual temperature distribution on the material layer surface or also within the layer cake can be determined by known measuring processes and used for designing control for a more even temperature distribution.

With regard to the device for producing a three-dimensional object from a solidifiable liquid or powder material, the task is solved by means of the following device:
a device for applying a layer of the material on a target surface in a construction space,
a device for flattening the material layer,
a device for radiating a selected part of the material layer with an energy beam or material spray,
a device for lowering the target surface within the construction space,
wherein the device includes at least one tempering device, which is provided within the construction space.

Therein, the target surface at the beginning of the manufacturing process is the construction space floor and, during the manufacturing, the respective upper-most material layer of the layer cake as it is being built up.

The inventive tempering device within the layer cake reduces component distortion since the temperature distribution within a layer of the layer cake can therewith be better homogenized and can sink more evenly beginning from the radiated areas of the layer cake upper surface down towards the floor of the construction space.

The tempering device can be designed for example, rod shaped, tubular shaped, grid shaped or slab shaped. It can be designed for example, as an evaporation cooler or as a fluid temperature dissipater, for example, a water or oil cooler (or could also function thermo-electrically).

In one advantageous embodiment the at least one tempering device is provided locationally fixed in the construction space. (In contrast to the sinkable or lowerable target surfaces). For this, the tempering device is for example, broad shaped in design and extends through the construction floor form-fittingly via a suitable bore hole. If the construction floor is sunk for sinking the target surface, then the tempering device can remain locationally fixed. Particularly advantageous is when the device and, in certain cases, the construction space floor is designed for variable or adaptive accommodation of the at least one tempering device. For this, for example, a number of suitable receptacles can be provided in predetermined distribution and arrangement (for example, a 2×2 matrix at regular intervals), in which one or more tempering devices can be provided, depending upon respective requirements, in varying number and arrangement. The respective unused receptacles can be closed by suitable means (for example, closure cap), so that the layer material cannot escape through the floor space.

In a further advantageous design the at least one tempering device includes varyingly temperable sectors. For example, a cooling rod subdivided into multiple individual controllable cooling chambers (=sectors).

Also advantageous is when the device exhibits at least one control or regulating device for later control or regulating of different tempering devices. Therewith for example, an inhomogeneous temperature distribution in the construction space may be pre-set, of which the interaction with the inhomogeneous temperature distribution due to the radiation of the layer cake may bring about overall a homogeneous temperature distribution of the layer cake.

Alternatively, or in addition, this homogenization can be further improved when the device exhibits at least one control or regulating device for later control or regulation of different sectors of at least one tempering device. The control device includes in certain cases a suitable sensing or measuring device for detecting the actual temperature distribution, or is connected with such a measuring device.

In the following, the inventive device and the inventive process will be described in greater detail on the basis of an illustrative example:

The exemplary device for producing a three-dimensional object of a solidifiable liquid or powder-form material is a conventional laser sinter device with the following equipment:
a device for applying a layer of the material upon a target surface in the construction space,
a device for flattening the material layer,
a device for radiating a selected part of the material layer with a laser beam,
a device for lowering the target surface within the construction space.

The conventional laser sinter device includes, in addition, a number of tempering devices, which are provided within the construction space, as well as a device for controlling the tempering devices.

The tempering devices are rod shaped and exhibit multiple individual, controllable cooling chambers (=sectors).

Within the construction space, which can be lowered in conventional manner, there is a further stationary floor with a plurality of receptacles for the tempering devices arranged in a regular 2×2 matrix. The lowerable construction floor exhibits bore holes arranged concurrently with the receptacles, through which the round shaped tempering devices project locationally fixed into the construction space. During lowering of the construction space floor the tempering devices appear to grow out of the construction space floor and are covered during the individual process steps respectively by one or also multiple material layers. The tempering devices not required in the respective application case are covered by suitable closure caps.

According to this illustrative embodiment the manufacture of the object occurs in conventional manner by means of the known process of selective laser sintering, wherein a tempering occurs within the layer cake. For this tempering, first suitable control parameters for the tempering device are determined. For this, first, a simulation of the conventional radiation process is carried out and the temperature distribution resulting therefrom is modeled or calculated. Subsequently there is carried out a corresponding simulation for computational optimization of the supplemental tempering to be superposed in the inner space of the construction space with respect to the minimization of the component distortion.

With the control parameters determined in this way, the tempering devices are controlled during the laser sintering process which runs in an otherwise conventional manner.

The supplemental tempering (besides the tempering as a result of the radiation) within the layer cake minimizes component warpage, since the temperature distribution within the layer cake, in particular within a layer of the layer cake, can thus be better homogenized and more evenly sink or drop beginning from the radiated areas of the upper surface down towards the floor of the construction space.

The tempering occurs at multiple positions in multiple layers of the construction space. Within a layer plane, with increasing distance of the tempering position to the radiated areas, a higher temperature to be superposed is specified, in order to obtain as a result of the superposing an essentially homogenized temperature distribution within a layer. Perpendicular to the layer planes a lower and lower temperature distribution in the direction towards the construction space floor is predetermined, in order to ensure an even as possible temperature reduction.

The inventive device and the inventive process have demonstrated themselves in the illustrative embodiments of the above described example as particularly suited for rapid manufacturing applications in the automobile industry.

In particular, a improvement in the construction quality with respect to the temperature dependent warpage can be achieved therewith.

Besides this, the invention can be used for increasing productivity, since it makes it possible to simultaneously produce multiple components in one large construction space. Until now the overlapping temperature distributions of multiple components have resulted in unacceptable component warpages. By means of the inventive device and the inventive process, the component warpage can be minimized in multiple components by suitable tempering within the construction space, in particular between adjacent component boundaries. This also makes it possible to enlarge the construction space to hitherto unachievable scales.

By means of numeric optimization processes (for example FEM-simulation) both the so called “packaging,” that is the distribution of multiple parts in a construction space, as well as the distribution of multiple tempering devices within the construction space, can be optimized. Thereby a maximum number of components can simultaneously be produced with optimal temperature conditions in one construction space.

1-11. (canceled)

12. A process for producing a three-dimensional object including the following steps:
applying and flattening a solidifiable liquid or powder material layer on a target surface,
irradiating or spraying a select part of the layer with an energy beam or material, corresponding to a cross section of the object, so that the material layer solidifies in this selected part, wherein the irradiated or sprayed part warms its environment,
repeating the steps of application and radiation for a plurality of layers, which form a layer cake, such that the solidified parts of adjacent layers join to form an object, wherein a tempering occurs within the layer cake.

13. The process according to claim 12, wherein the tempering occurs in multiple positions in at least one plane of the construction space.

14. The process according to claim 12, wherein the tempering occurs in multiple variable positions in at least one plane of the construction space.

15. The process according to claim 12, wherein the tempering occurs differentially at different positions within the construction space.

16. The process according to claim 12, wherein the control or regulation of the tempering occurs differentially within the construction space.

17. The process according to claim 12, wherein the control or regulation of the tempering occurs differentially at different positions within the construction space.

18. A device for producing a three-dimensional object from a solidifiable liquid or powder material, said device including:
a device for applying a layer of the material upon a target surface in a construction space,
a device for flattening the material layer,
a device for radiating or spraying a select part of the material layer with an energy or material beam,
a device for lowering the target surface within the construction space, and
at least one tempering device, which is provided within the construction space.

19. The device according to claim 18, wherein the at least one tempering device is provided locationally fixed in the construction space.

20. The device according to claim 18, wherein the construction floor is designed for receiving of at least one tempering device.

21. The device according to claim 18, wherein the construction floor is designed for the variable receiving of at least one tempering device.

22. The device according to claim 18, wherein the receptacle is in the form of a two-dimensional receptacle matrix.

23. The device according to claim 18, wherein the at least one tempering device includes independently or differentially temperable sectors.

24. The device according to claim 18, wherein the device includes at least one control or regulating device for separate control or regulation of various tempering devices.

25. The device according to claim 18, wherein the device includes at least one control or regulating device for separate control or regulating of different sectors of at least one tempering device.
